(19) United States
(12) Patent Application Publication
(10) Pub. No.: US 2018/0229256 A1
(43) Pub. Date: Aug. 16, 2018

(54) COATING BOOTH

(71) Applicant: TRINITY INDUSTRIAL CORPORATION, Toyota-shi, Aichi (JP)

(72) Inventors: Takashi HASHIMOTO, Nagoya-shi (JP); Yoshifumi TAKAGI, Chiryu-shi (JP)

(73) Assignee: TRINITY INDUSTRIAL CORPORATION, Toyota-shi, Aichi (JP)

(21) Appl. No.: 15/751,088

(22) PCT Filed: Aug. 24, 2016
(86) PCT No.: PCT/JP2016/074707

§ 371 Date: Feb. 7, 2018

(30) Foreign Application Priority Data
Sep. 24, 2015 (JP) 2015-186423

(51) Int. Cl. B05B 14/46; B05B 14/45; B05B 16/60

(52) U.S. Cl. CPC B05B 14/46; B05B 16/60; B05B 14/45

(57) ABSTRACT

A coating booth includes a water flow board laterally opposing a coat-processing region and structuring part of an inner side surface of the coating booth, a water supply unit supplying water to the upper edge of the front surface of the water flow board oriented toward the coat-processing region, to allow the water to flow down along the front surface of the water flow board, a water collection unit disposed below the water flow board and collecting the water flowed down from the water flow board, a plurality of air passages dispersedly provided at the water flow board penetrating through the front and rear sides of the water flow board, and an air intake chamber provided on the rear side of the water flow board and communicating with the coat-processing region via the plurality of air passages, and communicating with an air intake duct provided outside the coating booth.

### TECHNICAL FIELD

The present invention relates to a coating booth containing a coat-processing region in which a workpiece is coated with atomized paint.

### BACKGROUND ART

A conventionally known coating booth of such a kind includes a flat water bath containing water below a coat-processing region, and an exhaust tube penetrating through the water bath in the top-bottom direction. Further, below the water bath, an air intake passage connected to an air intake duct is provided. This structure allows air in the coat-processing region to flow downward and hit the water in the water bath, whereby paint in the air is collected by the water in the water bath. Here, when the air is drawn from the exhaust tube into the air intake passage, water at the surface of water contained in the water bath becomes mist-like and also drawn into the air intake passage, and remaining paint is collected as being coupled with the mist-like water (for example, see Patent Document 1).

### RELATED ART DOCUMENTS

### Patent Document

Patent Document 1: Japanese Patent Application Publication No. 2015-20129 (FIG. 1, [0024])

### SUMMARY OF INVENTION

### Problems to be Solved by the Invention

However, the above-described conventional coating booth is disadvantageous in that the air intake passage being disposed below the water bath necessitates a large-scale construction, incurring high installation costs.

The present invention has been made in view of the circumstances, and an object thereof is to provide a coating booth that can be installed at low costs.

### Means of Solving the Problems

A coating booth of the present invention which has been made to achieve the object described above is a coating booth containing a coat-processing region in which a workpiece is coated with atomized paint, the coating booth including a water flow board laterally opposing the coat-processing region and structuring a part of an inner side surface of the coating booth, a water supply unit supplying water to an upper edge of a front side surface of the water flow board oriented toward the coat-processing region, to allow the water to flow down along the front side surface of the water flow board, a water collection unit disposed below the water flow board and collecting the water flowed down from the water flow board, a plurality of air passages dispersedly provided at the water flow board and penetrating through front and rear sides of the water flow board, and an air intake chamber provided on the rear side of the water flow board and communicating with the coat-processing region via the plurality of air passages, and communicating with an air intake duct provided outside the coating booth.

### BRIEF DESCRIPTION OF THE DRAWINGS

FIG. 1 is a sectional side view of a coating booth according to one embodiment of the present invention.

FIG. 2 is a horizontal section view of the coating booth.

FIG. 3 is a sectional side view of an air distributing apparatus.

FIG. 4 is a perspective view of a wind pressure restricting board.

FIG. 5 is a perspective view of a water flow board.

FIG. 6 is a perspective view of a cyclone mechanism unit.

FIG. 7 is a perspective view of a water flow board according to a variation of the present invention.

FIG. 8 is a horizontal section view of the water flow board.

FIG. 9 is a perspective view of the water flow board according to a variation of the present invention.

### MODE FOR CARRYING OUT THE INVENTION

### First Embodiment

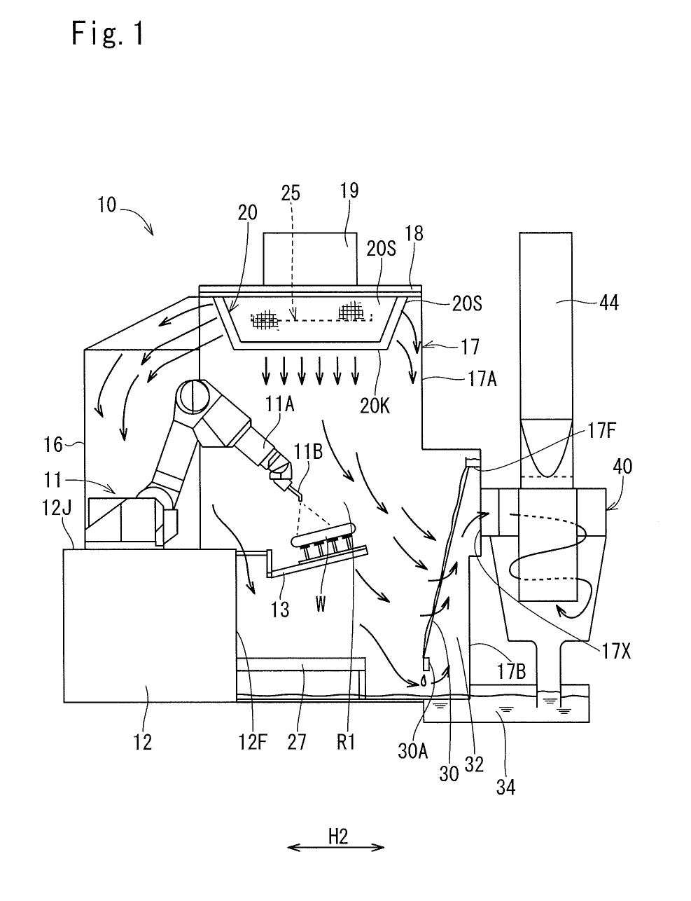

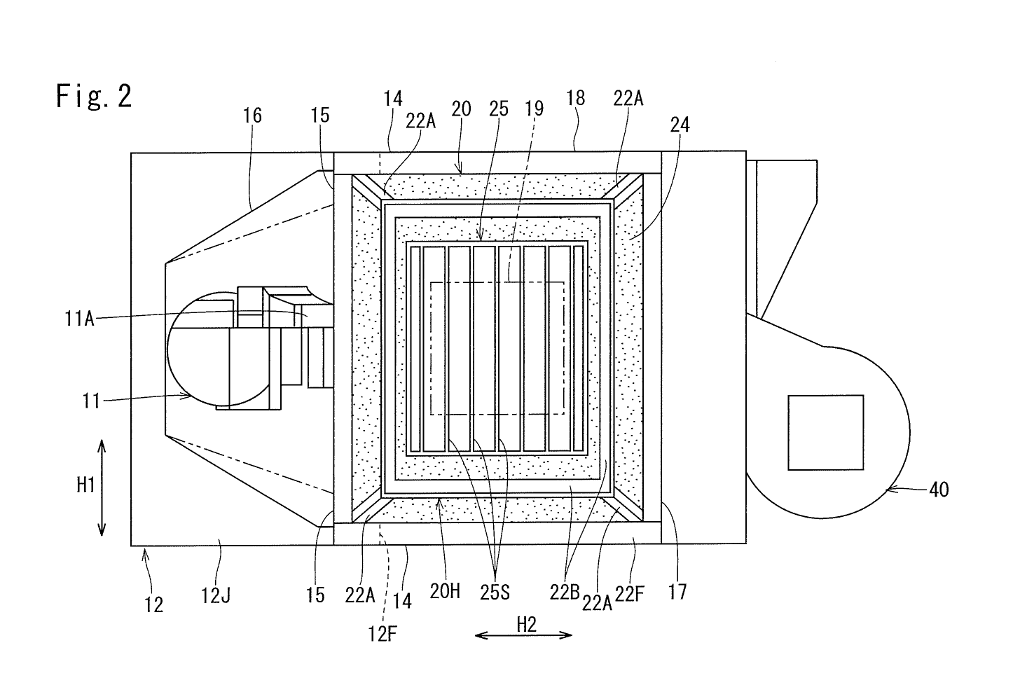

In the following, with reference to FIGS. 1 to 6, a description will be given of one embodiment of the present invention. As shown in FIG. 1, a coating booth 10 according to the present embodiment houses one coating robot 11. The coating robot 11 is mounted on a mount 12. The mount 12 is rectangular parallelepiped-shaped and extending in the horizontal direction. The coating robot 11 is disposed at the center in the longitudinal direction of the mount 12. In the following description, the horizontal direction in which the mount 12 extends is referred to as the “first horizontal direction H1” (see FIG. 2), and a horizontal direction perpendicular thereto is referred to as the “second horizontal direction H2”. Further, the coating robot 11 in its original posture shown in FIG. 1 is directed toward one side in the second horizontal direction H2. The direction in which the coating robot 11 is directed in its original posture is referred to as the “front side” or “front”, and the direction opposite thereto is referred to as the “rear side” or “rear”.

As shown in FIG. 1, in the coating booth 10, in front of the coating robot 11 and the mount 12, a coat-processing region R1 is provided. Further, a cantilever-like jig 13 projects from the upper portion of a front surface 12F of the mount 12. The jig 13 holds a workpiece W. An arm 11A of the coating robot 11 projects into the coat-processing region R1. Paint is sprayed downward from a coating gun 11B provided at the tip of the arm 11A to coat the workpiece W. At this time, in order to collect surplus atomized paint that did not attach to the workpiece W without leaking to the outside, the entire coat-processing region R1 is surrounded by first sidewalls 14, a second sidewall 15, a third sidewall 17, a top wall 18 and the like of the coating booth 10.

Specifically, as shown in FIG. 2, in the coating booth 10, a pair of first sidewalls 14, 14 opposing to each other in the first horizontal direction H1 having the coat-processing region R1 interposed therebetween each include a vertical and flat inner surface, and are perpendicular to the front surface 12F and an upper surface 12J of the mount 12. Further, while the one first sidewall 14 is provided with a not-shown workpiece feeding port for passing a workpiece W to the jig 13 in the coating booth 10, the other first sidewall 14 is provided with a not-shown workpiece delivery port for receiving the workpiece W from the jig 13 in the coating booth 10. A door is provided to each of the workpiece feeding port and the workpiece delivery port so as to be opened or closed. Further, on the mount 12, the second sidewall 15 provided between the rear ends of the pair of first sidewalls 14, 14 serves as a robot surrounding section 16 which is expanding rearward entirely excluding the opposite edge parts thereof.

In the robot surrounding section 16, a pair of side parts disposed on the opposite sides in the first horizontal direction H1 relative to the coating robot 11 each has an inner surface being flat and parallel to the vertical direction. The side parts are inclined so as to become closer to each other rearward. Further, the rear part of the robot surrounding section 16 has an inner surface that is flat and parallel to the vertical direction, and connects between the rear ends of the pair of side parts. Further, the upper part of the robot surrounding section 16 is inclined so that the inner surface becomes lower rearward and toward opposite sides.

The third sidewall 17 on the side opposite to the coating robot 11 with reference to the coat-processing region R1 has, at a portion upper than the intermediate position in the top-bottom direction of the coating booth 10 (specifically, the position upper than the mount 12), an inner surface being flat and parallel to the vertical direction. The third sidewall 17 is perpendicular to the pair of first sidewalls 14, 14. Further, as shown in FIG. 2, the top wall 18 covering the coat-processing region R1 from above has a shape of a quadrangle in which the first horizontal direction H1 is slightly greater than the second horizontal direction H2, and the third sidewall 17 and the first sidewalls 14, 14 are respectively connected to the outer edge parts of the three sides of the top wall 18. Further, to the opposite side parts of the outer edge part of the other side of the top wall 18, the second sidewall 15 is connected, and the robot surrounding section 16 is connected to the portion other than the opposite side parts.

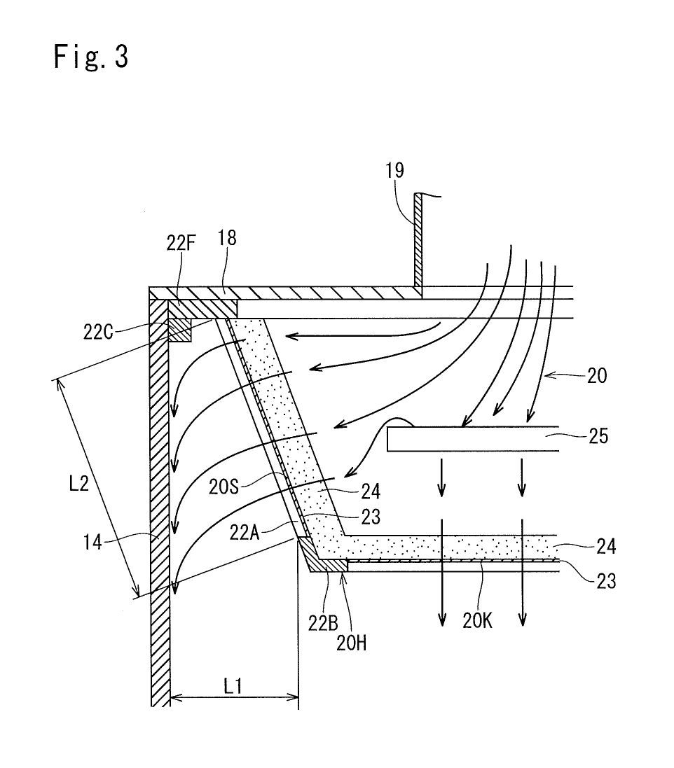

As shown in FIG. 1, the entire inner surface (the lower surface) of the top wall 18 excluding the outer edge part is covered with an air distributing apparatus 20. The entire air distributing apparatus 20 has a prismoid-shape, narrowing downward. As shown in FIGS. 2 and 3, the air distributing apparatus 20 is made up of a framework 20H, and a net 23 and a filter mat 24 attached to the framework 20H. The framework 20H has a structure in which four inclined supporting members 22A extend diagonally downward along the ridges of the prismoid from the four corners of the inner edge of a quadrangular frame-like plate member 22F. The lower ends of adjacent inclined supporting members 22A, 22A are connected to each other with a beam 22B. The net 23 is stretched across the lower surface and all the side surfaces of the framework 20H, and the filter mat 24 is laid on the inner side of the net 23.

As shown in FIG. 3, the air distributing apparatus 20 has its frame-like plate member 22F overlaid on the lower surface outer edge part of the top wall 18. In the air distributing apparatus 20, an opening inner than the frame-like plate member 22F is covered with the top wall 18. Further, as shown in FIG. 1, at the center of the top wall 18, a quadrangular tubular blower duct 19 is attached. Air is blown from the blower duct 19 directly downward. Thus, the pressure inside the air distributing apparatus 20 rises, and air is exhausted from the side surfaces and the lower surface of the air distributing apparatus 20 through the filter mat 24 and the net 23.

Further, as shown in FIG. 3, to the lower surface of the frame-like plate member 22F, a squared member 22C is attached along the outer edge part of the lower surface. The squared member 22C is disposed so as to be spaced apart from the framework 20H. The side surface of the squared member 22C and the side surface of the frame-like plate member 22F are flush with each other, and overlaid on the inner surface of the first sidewall 14 and the third sidewall 17. Further, the upper inner surface of the robot surrounding section 16 and the lower surface of the squared member 22C are disposed so as to be flush with each other.

Further, air blown out from a side air-blow surface 20S of the air distributing apparatus 20 (that is, the exposed surface of the net 23 being visually recognizable as seen from the side of the air distributing apparatus 20) flows downward along the inner surface of the first sidewalls 14 and the third sidewall 17. The blow-down speed of air at the inner surfaces such as the first sidewalls 14 becomes greater than the blow-down speed of air blown out from a lower air-blow surface 20K of the air distributing apparatus 20 (that is, the exposed surface of the net 23 that is visually recognizable as seen from the bottom of the air distributing apparatus 20). This is explained as follows. As compared to a width L1 of the horizontal air passing plane between the lower end of the side air-blow surface 20S and the inner surface of the first sidewalls 14 and the like, a width L2 of the side air-blow surface 20S is greater. Therefore, the flow rate of the air blowing directly downward from the horizontal air passing plane becomes greater than the flow rate of the air blowing directly downward from the lower air-blow surface 20K.

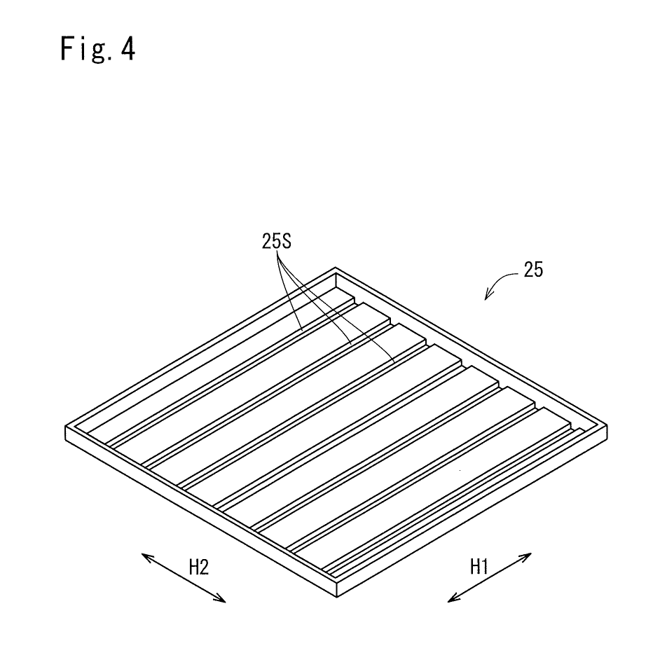

In order to prevent the lower air-blow surface 20K from receiving a greater inner pressure than that the side air-blow surface 20S does in the air distributing apparatus 20, the air distributing apparatus 20 contains a wind pressure restricting board 25 that receives air supplied from the blower duct 19. As shown in FIG. 4, the wind pressure restricting board 25 has a tray structure. The planar shape of the wind pressure restricting board 25 is a quadrangle slightly larger than the lower end opening of the blower duct 19. Further, at the bottom surface of the wind pressure restricting board 25, a plurality of slits 25S extending in the first horizontal direction H1 are dispersedly arranged in the second horizontal direction H2. Further, on the bottom surface of the wind pressure restricting board 25, sliding plates are stacked beside the slits 25S. A wing screw is passed through an elongated hole formed at each of the sliding plates, and tightened to a not-shown female screw hole formed at the wind pressure restricting board 25. Thus, the sliding plates can be shifted to arbitrary slide positions and fixed thereto, enabling to adjust the opening width of the slits 25S arbitrarily. The wind pressure restricting board 25 is supported by a not-shown supporting member extending from the top wall 18 or the framework 20H, and opposes to the lower end opening of the blower duct 19 while being suspended at the center in the top-bottom direction of the air distributing apparatus 20.

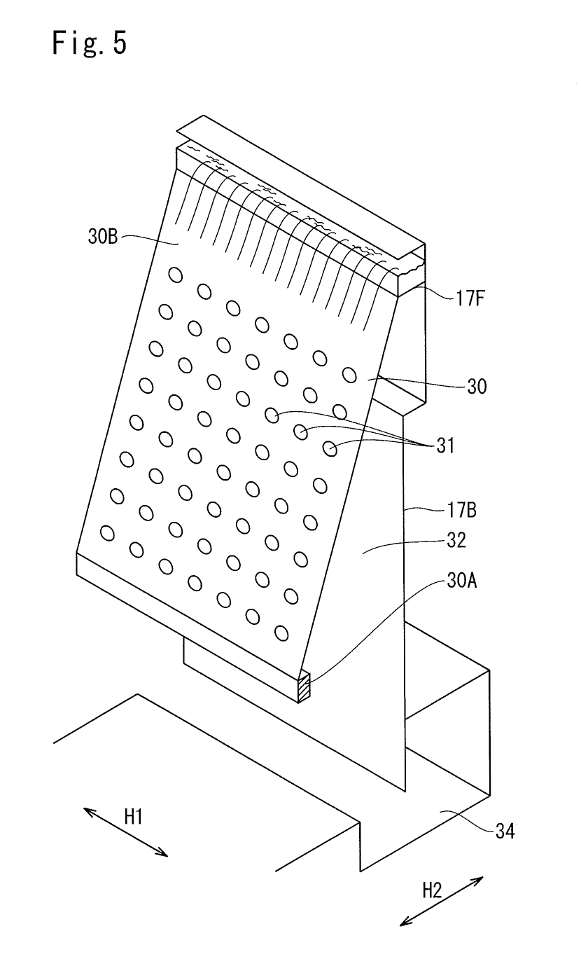

As shown in FIG. 1, as described above, the third sidewall 17 has, at the portion upper than the intermediate position in the top-bottom direction of the coating booth 10, the inner surface being flat and parallel to the vertical direction. Further, the third sidewall 17 is bent substantially crank-like at the intermediate position in the top-bottom direction of the coating booth 10, and the portion lower than the bent portion (hereinafter referred to as the “lower wall 17B”) is displaced outward relative to the upper portion (hereinafter referred to as the “upper wall 17A”). Further, as shown in FIG. 5, the lower wall 17B is further slightly bent substantially crank-like at the intermediate part upper end position in the top-bottom direction, whereby the lower side portion of the lower wall 17B is slightly displaced inward relative to the upper portion of the lower wall 17B.

At the inner surface upper end of the lower wall 17B, a water supply tank 17F is provided. The water supply tank 17F extends over the entire lateral direction (the first horizontal direction H1) of the lower wall 17B, and has a quadrangular groove-shaped structure with its upper surface opened. In the water supply tank 17F, from the lower side corner on the side spaced apart from the lower wall 17B, a water flow board 30 of the present invention is hung down diagonally below. The lower end of the water flow board 30 opposes to the inner lower surface of the coating booth 10 while being spaced apart therefrom. The inclination angle of the water flow board 30 relative to the vertical direction is, for example, from 3 degrees to 15 degrees. The lower end of the water flow board 30 is positioned substantially on the extension line of the inner surface of the upper wall 17A (see FIG. 1). Further, the opposite side parts of the entire third sidewall 17 and the entire water flow board 30 are connected to the pair of first sidewalls 14, 14. Thus, the space in the coating booth 10 is enclosed, and an air intake chamber 32 of the present invention is formed between the lower wall 17B and the water flow board 30.

As shown in FIG. 5, the water flow board 30 is structured of a plate member 30B. In the water flow board 30, at a portion lower than the connecting portion with the upper end of the lower wall 17B, a plurality of ventilation holes 31 (corresponding to the “air passages” and the “through holes” of the present invention) are arranged in a matrix. Further, the lower end of the water flow board 30 is supported by a reinforcing bar 30A interposed between the first sidewalls 14, 14.

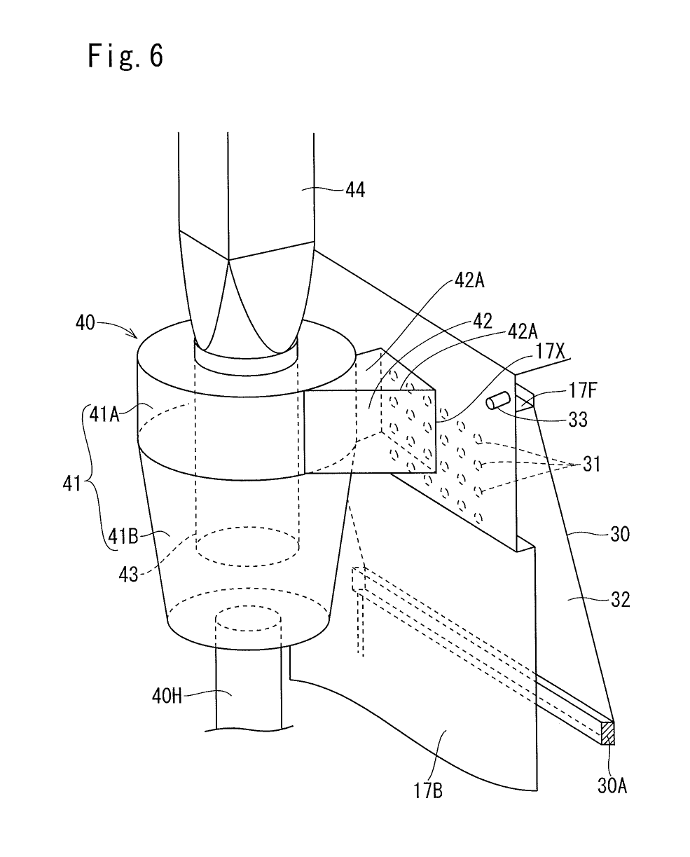

As shown in FIG. 6, a water supply tube 33 penetrates through the outer surface of the lower wall 17B into the water supply tank 17F. Water is supplied from the water supply tube 33 into the water supply tank 17F, and water overflowed the water supply tank 17F along the entire longitudinal direction flows down along the water flow board 30. Thus, the water flows down along the front surface of the water flow board 30 oriented toward the coat-processing region R1, whereby the entire front surface of the water flow board 30 is covered with a film of water. Note that, the water supply tube 33 and the water supply tank 17F correspond to the “water supply unit” of the present invention.

The lower part in the coating booth 10 has a bath structure capable of storing water. Further, as shown in FIG. 1, at the lower surface of the coating booth 10, a drain groove 34 (corresponding to the “water collection unit” of the present invention) is formed below the lower wall 17B. The drain groove 34 extends in the first horizontal direction H1, and the lower end of the lower wall 17B is positioned at the intermediate part in the width direction of the drain groove 34. Further, in the drain groove 34, a not-shown drain pipe is connected to a portion positioned outside the coating booth 10. The water volume drained from the drain pipe is controlled so as to maintain the state where the entire lower part of the coating booth 10 is covered with water and the lower end of the lower wall 17B is immersed in water (the state shown in FIG. 1). Note that, below the jig 13, a pedestal 27 that serves as a scaffold in maintenance is provided so as to position higher than the water surface.

As shown in FIG. 1, an exhaust port 17X (corresponding to the “suction port” of the present invention) is formed at the upper part of the lower wall 17B. To the exhaust port 17X, a cyclone mechanism unit 40 is connected from the outside of the lower wall 17B. Via the cyclone mechanism unit 40, an air intake duct 44 communicates with the air intake chamber 32 of the coating booth 10. Specifically, as shown in FIG. 6, the cyclone mechanism unit 40 includes an inner tubular member 43 at the center of an outer tubular member 41. The upper side of the outer tubular member 41 is a cylindrical part 41A, and the lower side lower than the cylindrical part 41A is a tapered part 41B where the diameter becomes smaller toward a lower level.

A drain tube 40H is hung down from the bottom wall of the outer tubular member 41. The lower end of the drain tube 40H is set in the water in the drain groove 34 and thereby closed. Further, the inner tubular member 43 penetrates through the center of the upper surface wall of the outer tubular member 41, and the air intake duct 44 is connected to the upper end of the inner tubular member 43. On the other hand, the lower end of the inner tubular member 43 is disposed at a position upwardly spaced apart from the inner lower surface of the outer tubular member 41. Further, an introduction duct 42 projects from the outer tubular member 41, and the end of the introduction duct 42 is connected to the exhaust port 17X at the lower wall 17B. The introduction duct 42 is disposed in such a manner that the planes being the extension of inner side surfaces 42A, 42A do not intersect with the inner tubular member 43. When a not-shown fan connected to the air intake duct 44 is driven, air in the air intake chamber 32 is drawn in, from the introduction duct 42, between the outer tubular member 41 and the inner tubular member 43 and swirls downward. The centrifugal force that acts in this process presses mist-like water and paint against the inner surface of the outer tubular member 41, thereby to separate the mist-like water and the paint from air. Then, just the air is drawn into the inner tubular member 43 from the lower end of the introduction duct 42 through the inner tubular member 43, and released, for example, to the outside air.

Note that, the inner surface of the cyclone mechanism unit 40 is Teflon-coated (“Teflon” is a registered trademark). Further, in the present embodiment, the lower wall 17B corresponds to the “booth sidewall” of the present invention.

The foregoing is the description of the structure of the coating booth 10 according to the present embodiment. Next, a description will be given of the operation and effect of the coating booth 10. When the coating robot 11 is coating a workpiece W in the coating booth 10, the state where water flows down along the water flow board 30 is maintained. Further, air is supplied to the air distributing apparatus 20 from the blower duct 19 and the inside of the air distributing apparatus 20 is maintained in a positive pressure state. Further, air in the air intake chamber 32 is drawn into the air intake duct 44, whereby the inside of the air intake chamber 32 is maintained in a negative pressure state. As exemplarily represented by arrows in FIG. 1, air is blown out from the side air-blow surface 20S and the lower air-blow surface 20K of the air distributing apparatus 20, and the air descends in the entire coating booth 10. Part of the descended air flows from the coat-processing region R1 around the water flow board 30 toward the water flow board 30, and hits the water flowing along the front surface of the water flow board 30. Thereafter, the air is drawn into the air intake chamber 32 through the ventilation holes 31 of the water flow board 30. Further, the air having reached the lower part of the coating booth 10 is drawn into the air intake chamber 32 passing through the water flowing down from the lower end of the water flow board 30. In this manner, the surplus atomized paint not having been used in coating the workpiece W is coupled with the water flowing along the water flow board 30 and collected.

Here, the air intake chamber 32 spreads downward and the exhaust port 17X is disposed at the upper part of the air intake chamber 32 and, therefore, a suction pressure is higher on the upper side in the air intake chamber 32. Accordingly, air is strongly drawn in on the upper side of the water flow board 30, and the air is mildly drawn toward the air intake chamber 32 on the lower side of the water flow board 30. Thus, the surplus paint around the workpiece W can be efficiently collected.

Further, when air is drawn into the air intake chamber 32 from the ventilation holes 31, the water flowing along the water flow board 30 becomes mist-like and drawn into the air intake chamber 32 via the ventilation holes 31. Accordingly, the atomized paint having failed to be collected combines with the mist-like water in the air intake chamber 32. Then, the combined paint and mist-like water become droplets and are collected into the drain groove 34, or drained from the exhaust port 17X. The water collected in the drain groove 34 is separated into water and paint by any known method, and only the water is reused. Further, the air exhausted from the exhaust port 17X passes through the cyclone mechanism unit 40. At this time, the mist-like water and paint contained in the air are pressed against the inner surface of the outer tubular member 41 and separated from the air, and collected. Then, the air is exhausted to the outside air from the air intake duct 44.

As described above, the coating booth 10 according to the present embodiment is capable of efficiently collecting atomized paint. Since the water flow board 30 along which water for collecting the atomized paint is disposed in such a manner as to laterally oppose to the coat-processing region R1 and as to configure a part of the inner side surface of the coating booth 10, the air intake chamber 32 behind the water flow board 30 is positioned at the side part of the coating booth 10. Thus, the installation construction of the coating booth 10 according to the present embodiment becomes easier as compared to that of the conventional coating booth, and the coating booth 10 can be installed at lower costs. Further, by virtue of the water flow board 30 having a simple structure in which the ventilation holes 31 are formed to penetrate through the plate member, the water flow board 30 can be manufactured at low costs. Still further, by virtue of the water flow board 30 being inclined, as compared to the case where the water flow board 30 is set in parallel to the vertical direction, the speed of the water flowing along the water flow board 30 is suppressed, whereby the amount of water to be used is reduced and water supply becomes less likely to run out. Further, by virtue of the cyclone mechanism unit 40 being attached to the outer surface of the lower wall 17B partitioning between inside and outside of the coating booth 10, mist-like water containing paint is separated from air immediately after exhausted from the coating booth 10. This simplifies the structure of the exhaust path outside the coating booth 10.

### OTHER EMBODIMENT

The present invention is not limited to the above-described embodiment and, for example, embodiments such as described below are also included in the technical scope of the present invention. In addition, various modifications can be made within the scope not departing from the spirit of the present invention.

(1) The coating booth 10 according to the above-described embodiment houses just a single coating robot 11. On the other hand, for example, a plurality of coating robots may be juxtaposed to each other to structure a coating line, and the present invention may be applied to an elongated coating booth conforming to the coating line.

(2) The water flow board 30 according to the above-described embodiment is inclined relative to the vertical direction. On the other hand, a water flow board may be disposed in parallel to the vertical direction, and water may be caused to flow along the water flow board.

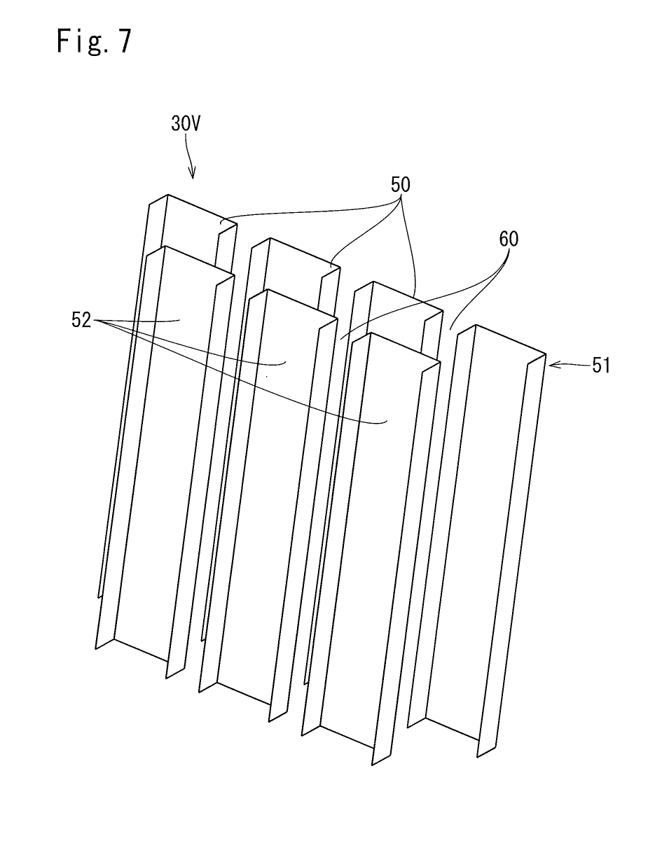

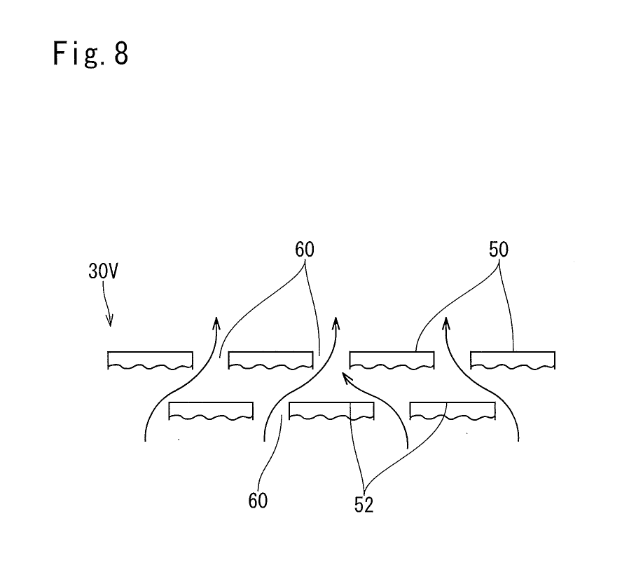

(3) Further, as a water flow board 30V shown in FIGS. 7 and 8, it is also possible to employ a structure including a row of gutters 51 in which a plurality of first gutters 50 are laterally juxtaposed to and spaced apart from each other, each of the first gutters having a quadrangular groove shape extending in the top-bottom direction, and second gutters 52 each having a quadrangular groove shape so as to cover a gap between adjacent ones of the first gutters 50, 50 on the coat-processing region R1 side. A water supply nozzle may be provided at the upper part of the first and second gutters 50, 52 to cause water to flow in the gutters 50, 52. As shown in FIG. 8, gaps between the first gutters 50 and the second gutters 52 may serve as air passages 60, and air may be drawn toward the air intake chamber through the air passages 60. This structure stabilizes the flow of water in the water flow board 30V.

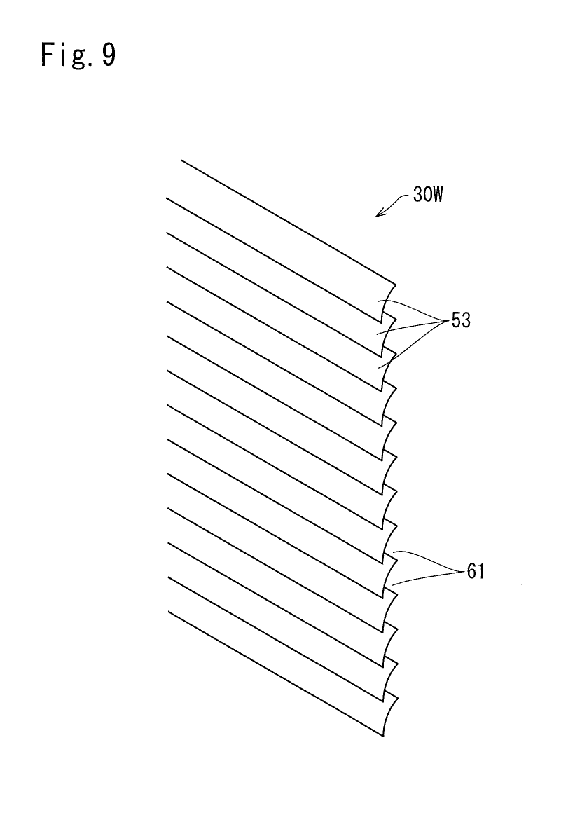

(4) Further, as a water flow board 30W shown in FIG. 9, it is also possible to employ a structure in which a plurality of slats 53 extending in the lateral direction are arranged in the top-bottom direction, each of the slats 53 having its upper edge covered by the lower edge of the upper adjacent one of the slats 53 as seen from the coat-processing region, that is, a so-called blind structure. Gaps between the slats 53, 53 serve as air passages 61, and air may be drawn toward the air intake chamber through the air passages 61. This structure easily causes air and water to be brought into contact with each other when the water passes between the slats 53, 53, whereby paint can be efficiently collected.

### DESCRIPTION OF THE REFERENCE NUMERAL

10 COATING BOOTH
17B LOWER WALL (BOOTH SIDEWALL)
17X EXHAUST PORT (SUCTION PORT)
30, 30V, 30W WATER FLOW BOARD
31 VENTILATION HOLE (AIR PASSAGE, THROUGH HOLE)
32 AIR INTAKE CHAMBER
34 DRAIN GROOVE (WATER COLLECTION UNIT)
40 CYCLONE MECHANISM UNIT
44 AIR INTAKE DUCT
50 FIRST GUTTER
51 ROW OF GUTTERS
52 SECOND GUTTER
53 SLAT
60, 61 AIR PASSAGE
R1 COAT-PROCESSING REGION
W WORKPIECE

1-6. (canceled)

7. A coating booth containing a coat-processing region in which a workpiece is coated with atomized paint, the coating booth comprising:
a water flow board laterally opposing to the coat-processing region and structuring a part of an inner side surface of the coating booth;
a water supply unit supplying water to an upper edge of a front side surface of the water flow board oriented toward the coat-processing region, to allow the water to flow down along the front side surface of the water flow board;
a water collection unit disposed below the water flow board and collecting the water flowed down from the water flow board;
a plurality of air passages dispersedly provided at the water flow board and penetrating through front and rear sides of the water flow board; and
an air intake chamber provided on the rear side of the water flow board and communicating with the coat-processing region via the plurality of air passages, and communicating with an air intake duct provided outside the coating booth.

8. The coating booth according to claim 7, wherein the water flow board is inclined in so as to advance toward the coat-processing region greater at a lower level.

9. The coating booth according to claim 7, further comprising:
a booth sidewall opposing the water flow board from the air intake chamber, and partitioning between inside and outside of the coating booth;
a suction port penetrating through the booth sidewall; and
a cyclone mechanism unit provided at the air intake duct and attached to an outer surface of the booth sidewall, the cyclone mechanism unit communicating with an inner space of the air intake chamber via the suction port and separating mist-like water and air from each other.

10. The coating booth according to claim 8, further comprising:
a booth sidewall opposing the water flow board from the air intake chamber, and partitioning between inside and outside of the coating booth;
a suction port penetrating through the booth sidewall; and
a cyclone mechanism unit provided at the air intake duct and attached to an outer surface of the booth sidewall, the cyclone mechanism unit communicating with an inner space of the air intake chamber via the suction port and separating mist-like water and air from each other.

11. The coating booth according to claim 7, wherein the water flow board is structured by a plate member provided with a plurality of through holes as the plurality of air passages.

12. The coating booth according to claim 8, wherein the water flow board is structured by a plate member provided with a plurality of through holes as the plurality of air passages.

13. The coating booth according to claim 9, wherein the water flow board is structured by a plate member provided with a plurality of through holes as the plurality of air passages.

14. The coating booth according to claim 10, wherein the water flow board is structured by a plate member provided with a plurality of through holes as the plurality of air passages.

15. The coating booth according to claim 7, wherein
the water flow board comprises:
a row of gutters in which a plurality of first gutters are laterally juxtaposed to and spaced apart from each other, each of the first gutters having a shape of a quadrangular groove extending in a top-bottom direction for allowing water to flow down inside, and
second gutters each having a shape of a quadrangular groove extending in the top-bottom direction for allowing water to flow down inside, each of the second gutters covering, on the coat-processing region side, a clearance between adjacent ones of the first gutters, and
gaps between the first gutters and the second gutters comprise the plurality of air passages, respectively.

16. The coating booth according to claim 8, wherein
the water flow board comprises:
a row of gutters in which a plurality of first gutters are laterally juxtaposed to and spaced apart from each other, each of the first gutters having a shape of a quadrangular groove extending in a top-bottom direction for allowing water to flow down inside, and
second gutters each having a shape of a quadrangular groove extending in the top-bottom direction for allowing water to flow down inside, each of the second gutters covering, on the coat-processing region side, a clearance between adjacent ones of the first gutters, and
gaps between the first gutters and the second gutters comprise the plurality of air passages, respectively.

17. The coating booth according to claim 9, wherein
the water flow board comprises:
a row of gutters in which a plurality of first gutters are laterally juxtaposed to and spaced apart from each other, each of the first gutters having a shape of a quadrangular groove extending in a top-bottom direction for allowing water to flow down inside, and
second gutters each having a shape of a quadrangular groove extending in the top-bottom direction for allowing water to flow down inside, each of the second gutters covering, on the coat-processing region side, a clearance between adjacent ones of the first gutters, and
gaps between the first gutters and the second gutters comprise the plurality of air passages, respectively.

18. The coating booth according to claim 10, wherein
the water flow board comprises:
a row of gutters in which a plurality of first gutters are laterally juxtaposed to and spaced apart from each other, each of the first gutters having a shape of a quadrangular groove extending in a top-bottom direction for allowing water to flow down inside, and
second gutters each having a shape of a quadrangular groove extending in the top-bottom direction for allowing water to flow down inside, each of the second gutters covering, on the coat-processing region side, a clearance between adjacent ones of the first gutters, and
gaps between the first gutters and the second gutters comprise the plurality of air passages, respectively.

19. The coating booth according to claim 7, wherein
the water flow board has a structure in which a plurality of slats extending in a lateral direction are arranged in a top-bottom direction, each of the slats having its upper edge covered, on the coat-processing region side, by a lower edge of an upper adjacent one of the slats, and
gaps between the slats comprise the plurality of air passages, respectively.

20. The coating booth according to claim 8, wherein
the water flow board has a structure in which a plurality of slats extending in a lateral direction are arranged in a top-bottom direction, each of the slats having its upper edge covered, on the coat-processing region side, by a lower edge of an upper adjacent one of the slats, and
gaps between the slats comprise the plurality of air passages, respectively.

21. The coating booth according to claim 9, wherein
the water flow board has a structure in which a plurality of slats extending in a lateral direction are arranged in a top-bottom direction, each of the slats having its upper edge covered, on the coat-processing region side, by a lower edge of an upper adjacent one of the slats, and
gaps between the slats comprise the plurality of air passages, respectively.

22. The coating booth according to claim 10, wherein
the water flow board has a structure in which a plurality of slats extending in a lateral direction are arranged in a top-bottom direction, each of the slats having its upper edge covered, on the coat-processing region side, by a lower edge of an upper adjacent one of the slats, and
gaps between the slats comprise the plurality of air passages, respectively.
